(19) United States
(12) Patent Application Publication
(10) Pub. No.: US 2026/0264127 A1
(43) Pub. Date: Sep. 10, 2026

(54) SQUEEZING ROLLER HAVING AN INTERNAL DRIVE FOR A COLD ROLLING SYSTEM

(71) Applicant: PRIMETALS TECHNOLOGIES AUSTRIA GMBH, Linz (AT)

(72) Inventors: Martin BERGMANN, Linz (AT); Gernot DIRISAMER, Grieskirchen (AT); Roland KELLERMAYR, St. Marien (AT); Bernhard SCHINAGL, Ansfelden (AT)

(73) Assignee: PRIMETALS TECHNOLOGIES AUSTRIA GMBH, Linz (AT)

(21) Appl. No.: 19/165,651

(22) PCT Filed: Feb. 12, 2024
(86) PCT No.: PCT/EP2024/053476

§ 371 Date: Sep. 16, 2025

(30) Foreign Application Priority Data
Mar. 22, 2023 (EP) 23163499.9

(51) Int. Cl. B21B 45/02; B21B 41/08

(52) U.S. Cl. CPC B21B 45/0284; B21B 41/08; B21B 45/0281; B21B 2203/26

(57) ABSTRACT

A device and a method for removing cooling lubricant during rolling of a rolled strip in a cold rolling system having at least one roll stand. The device includes a squeezing roller which is arranged between a first and a second roll rack of the roll stand. The squeezing roller is mounted in a holder to rotate about a rotational axis and includes a roller casing and an internal electric rotary drive which is designed as an internal rotor. By means of a positioning device, the squeezing roller can be positioned against the rolled strip. An open- and closed-loop control device actuates the rotary drive synchronously to a current speed of the rolled strip behind the roll stand such that the roller casing rolls on a surface of the rolled strip without slip and guides cooling lubricant from the rolled strip in a lateral direction.

### CROSS-REFERENCE TO RELATED APPLICATIONS

The present application is a national phase application of PCT Application No. PCT/EP2024/053476, filed Feb. 12, 2024, entitled “SQUEEZING ROLLER HAVING AN INTERNAL DRIVE FOR A COLD ROLLING SYSTEM”, which claims the benefit of European Patent Application No. 23163499.9, filed Mar. 22, 2023, each of which is incorporated by reference in its entirety.

### BACKGROUND OF THE INVENTION

### 1. Field of the Invention

The invention relates to a device and a method for removing cooling lubricant during rolling of a rolled strip in a cold rolling mill with at least one roll stand.

### 2. Description of the Related Art

A cold rolling mill for rolling flat rolling products—for example a tandem roll train—comprises at least one roll stand, preferably a plurality of roll stands, through which the flat rolling stock successively passes. The cold rolling mill may also be a reversing rolling mill comprising one or more roll stands, through which the rolled strip passes in an alternating direction.

The flat rolling stock is usually a rolled strip made of steel. Each roll stand of the cold rolling mill comprises at least two working rollers which together form a roll nip, through which the rolled strip is passed. For the insertion (‘threading’) of the initial section of a rolled strip (also referred to as ‘strip head’) into the roll stand, the latter is ‘opened’, i.e., the working rolls are moved apart in the roll stand to such an extent that the roll nip is greater than the strip thickness of the rolled strip to be threaded in. After threading in has taken place, the roll stand is ‘closed’ again, i.e., the roll nip is reduced to such an extent that the working rolls make contact with the threaded-in strip.

In addition, a tensile force (what is referred to as ‘strip tension’) is built up on the rolled strip downstream of the roll stand, so that the rolled strip passes through the roll stand along a so-called strip running line during the rolling operation. The strip running line is oriented substantially horizontally directly upstream and downstream of the roll nip of a roll stand. During rolling in the roll stand, the thickness of the rolled strip is reduced by the action of the working rolls to a predetermined outlet thickness downstream of the respective roll stand, said outlet thickness corresponding to the inlet thickness of an optionally subsequently arranged roll stand of the cold rolling mill. The region between two roll stands arranged consecutively is also referred to as an intermediate stand region.

Furthermore, during the passage of the rolled strip through a roll stand, a cooling lubricant is usually applied to the working rolls of the roll stand and/or to the rolled strip in order to assist the process of reducing the thickness of the rolled strip and to dissipate the heat resulting from the forming process. The cooling lubricant is usually a lubricating emulsion, for example water containing up to 5% pure lubricant; alternatively, however, pure lubricant, such as pure rolling oil, may also be used. Below the working rolls there is usually a collecting means for the applied cooling lubricant, which is subsequently collected and recycled.

In cold rolling mills, what are referred to as squeezing rollers are each used directly downstream of a roll stand, a squeezing roller being positioned on the upper side of the rolled strip with the aid of an assigned positioning mechanism and, during the rolling operation, guiding or deflecting said rolled strip into a certain strip running line through the roll stand. This retains the cooling lubricant which is used during rolling and accumulates on the upper side of the rolled strip, and said cooling lubricant is prevented from spreading into the intermediate stand region or from entering the subsequent roll stand. This is necessary since it is possible that measuring units which would be disturbed if the cooling lubricant were not removed may be located in the intermediate stand region or because a visual inspection of the rolled strip is intended to be made possible. It may also be necessary to separate different cooling lubricant systems and lubricant systems which are assigned to individual roll stands. In this case, when the squeezing roller is positioned against the rolled strip, the lowest point of the latter usually comes to lie above a collecting means, so that cooling lubricant located on the rolled strip is removed from the rolled strip by the squeezing roller in a direction transverse to the strip running line and is picked up by the collecting means.

Away from the immediate vicinity of the roll nip of a roll stand—i.e., within the range from about 0.5 m upstream and downstream of the roll stand in the intermediate stand region—the strip running line of a rolled strip does not necessarily run in a straight line, but is influenced, for example, by tensile measuring rollers or flatness measuring rollers. In addition, the strip running line can be adjusted with the aid of further rollers depending on the properties of the rolled strip concerned or its production parameters. For example, rolled strips of a certain product class have to be rolled in a roll stand with lubricant applied on the outlet side, which requires the use of a corresponding squeezing roller to prevent lubricant from entering the following intermediate stand region. On the other hand, the production of rolled strips of other product classes may require no or no significant application of lubricant and therefore a squeezing roller does not have to be positioned against the rolled strip during the rolling of such strips.

Squeezing rollers are typically smooth-running—for example in the form of a hollow cylinder with a low moment of inertia—and are driven by the rolled strip by friction, so that ideally no relative movement (slipping) occurs between the squeezing roller and the driving rolled strip.

In practice, however, slipping often occurs with such passively driven squeezing rollers, particularly if large amounts of emulsion or emulsions with a high lubricant content are used. In particular, slipping squeezing rollers downstream of the first roll stands through which a rolled strip passes may cause undetected scratches and strip damage, which are, however, discovered only by the lapping in the subsequent roll stands in a treatment plant located downstream of the cold rolling mill. In such cases, large amounts of scrap material are produced without having been able to be identified and prevented at an early stage.

Cooling lubricant remaining on the surface of the rolled strip reduces the friction between the squeezing roller and the rolled strip, thereby reducing the torque transmitted from the rolled strip to the squeezing roller. In some operating conditions (depending on the strip thickness, the strip tension and the strip speed), this causes slipping between the squeezing roller and the rolled strip, and this, in turn, can cause damage to the strip surface in the form of slip scratches.

As a rule, squeezing rollers do not have their own drive, nor is their rotational movement during rolling of a rolled strip monitored. In these circumstances, the described problems can therefore be identified only in the form of quality defects of the final product and cannot be prevented at an early stage, since there are no reliable detection mechanisms or adjustment options for preventing an asynchronous behavior between the squeezing roller and the rolled strip.

Inspection of the strip surface in combination with rotational speed monitoring of the squeezing roller enables the operating conditions in which slipping occurs to be identified, but not prevented. Although a reduction in the moment of inertia of the squeezing roller leads to improved carrying along of the squeezing roller by the rolled strip, slipping cannot be ruled out for all operating conditions, especially when there is a high lubricant content in the cooling lubricant. Even if the surface of the squeezing roller is modified (for example by increasing its roughness), the squeezing roller cannot be used continuously and reliably.

Another way to counteract the aforementioned slipping is to increase the contact pressure with which a squeezing roller is positioned against a rolled strip: thus, U.S. Pat. No. 4,323,122 A discloses rollers positioned in pairs against a rolled strip for the removal of lubricant from a rolled strip, wherein the lower of the two rollers is a counter roller, by means of which a corresponding positioning pressure for the upper squeezing roller can be realized. A pressurized liquid can be applied to the counter roller to adjust the surface contour thereof, and therefore a uniform contact pressure is achieved along the contact line of the two rollers with the rolled strip. Disadvantages include, firstly, the increased outlay on design of the lower counter roller and, secondly, a separate control process is necessary in order to suitably adjust the corresponding shaping of the counter roller to the respective production conditions.

Alternatively, cooling lubricant remaining on a rolled strip can also be removed by being blown off: in this connection, EP 0 513 632 A1 discloses a slot nozzle, to which a pressurized gas is applied and the outlet opening of which is oriented transversely to a strip running direction, wherein the discharged gas jet is directed with an inclination of 45° to 90° against the strip running direction, and wherein the discharge velocity of the gas jet lies within a range of 0.3 to 2 Mach. A disadvantage of this solution is the high energy requirement for achieving a gas jet with such a high discharge velocity. In addition, there is a risk of contamination of the environment of the rolling mill by the cooling lubricant, if the latter forms a fluid level of several millimeters on the rolled strip and is blown off with a high pressure gas jet.

Another measure to prevent slipping between a squeezing roller and the rolled strip can consist in a drive for the squeezing roller, so that the latter is not rotated or is not rotated exclusively by the rolled strip by friction. However, due to lack of space in a roll stand, it does not appear possible to use a drive arranged outside the squeezing roller, because a squeezing roller—as viewed along its axial direction—is usually arranged between the housing columns of the roll stand.

DE 10 2017 214 412 A1 discloses an internally arranged electric motor with a rotor and a stator for a roller element for strip-shaped rolling stock, wherein, without interconnection of a clutch or a transmission, the rotor is connected directly to the roller element and the stator directly to a frame, on which the roller element is rotatably mounted. The rotary drive is designed as what is referred to as an ‘external rotor’, in which a rotor rotates around a fixed electric stator. In contrast, in an electric rotary drive referred to as an ‘internal rotor’, the rotor rotates—as viewed in the radial direction—within a spatially fixed stator.

A disadvantage of the drive disclosed by DE 10 2017 214 412 A1 is that powerful permanent magnets have to be used for the stator for space reasons in an electric rotary drive designed as an external rotor. The permanent magnets are arranged on the inside of the shell surface of the roller element and are therefore located in the direct vicinity of its surface. Since, as a rule (inter alia, for cost reasons), magnetically shielding material is not used for squeezing rollers, the magnetic fields of the permanent magnets penetrate the surface of the squeezing roller without being attenuated and can lead to magnetic particles adhering thereto, so that stripy patterns or imprints appear on the rolled metal strip during the rolling operation.

### SUMMARY OF THE INVENTION

The invention is therefore based on the object of overcoming the disadvantages of the solutions known from the prior art for removing cooling lubricant from a rolled strip and of providing a constructive solution which, during the cold rolling of a rolled strip, prevents the entry of cooling lubricant into the subsequent roll stand—even at a level of several centimeters on the rolled strip—and reliably prevents slipping between a squeezing roller and the rolled strip. A further aspect of the invention is that the proposed solution can be structurally realized in a simple manner and can be used even in confined space conditions in the roll stand region.

This object is achieved according to the invention by means of a device as claimed. Preferred refinements of the device according to the invention are the subject matter of the dependent device claims.

A device according to the invention is used for removing cooling lubricant during rolling of a rolled strip in a cold rolling mill mentioned at the beginning. The cold rolling mill comprises at least one roll stand which has a first and a second roll housing, between which the rolled strip passes during the rolling operation. The device according to the invention comprises a squeezing roller, which can be arranged between the first and second roll housing of the roll stand. The squeezing roller has a roller shell and an internal electric rotary drive. The rotary drive is fixedly (i.e., mechanically rigidly) connected to the roller shell, has a stator and a rotor, and is designed as an internal rotor.

A rotary drive arranged internally—i.e., in the interior of the squeezing roller—advantageously enables little structural space to be required for the squeezing roller between the respective roll housings of the roll stand. The rotary drive can be designed in such a way that only the fixed stator is supplied with electrical drive energy, while the rotor is rotated due to the electromagnetic currents induced by the stator. In this way, wear-prone sliding contacts of the rotary drive can be advantageously avoided. In addition, an internal rotary drive enables a compact and maintenance-friendly design because, in the event of damage, the squeezing roller including the rotary drive can be replaced as a whole; there is no need to replace the drive module separately (as, for example, in the case of a squeezing roller with an externally arranged drive) or a coupling between the drive and the squeezing roller and to align same.

Furthermore, a rotary drive designed as an internal rotor affords the advantage that any permanent magnets of the internal rotor are arranged at a sufficient distance from the surface of the squeezing roller and that magnetically shielding material can be used as required for the stator. This advantageously prevents a disturbing magnetic field penetration of the electric rotary drive to the surface of the squeezing roller.

The device according to the invention further comprises a mount, in which the squeezing roller is mounted rotatably about an axis of rotation R, wherein the axis of rotation R runs substantially transversely to a strip running line. In addition, the device according to the invention comprises a positioning device for positioning the squeezing roller against the rolled strip, and a control means for activating the rotary drive and the positioning device. In this connection, ‘activation’ is understood to mean both the outputting of control signals or control commands to the respective unit without feedback (feed-forward control) and the repeated sending thereof in conjunction with a control loop.

Furthermore, a current speed v of the rolled strip downstream of the relevant roll stand is known to the control means. This is the current value of the strip speed of the rolled strip along a strip running line downstream of the roll stand and relative to the roll stand. This speed can be measured, for example, by means of a tension measuring roller or by means of a contactlessly operating speed measuring device (e.g., on the basis of the laser Doppler principle) and transmitted to the control means.

The current speed v of the rolled strip downstream of the roll stand corresponds exactly with the revolving speed of the surfaces of the working rolls thereof only at the so-called ‘neutral point’ within the roll nip. With respect to the rotating working roll surfaces, the rolled strip entering the roll stand has a lag, and the rolled strip leaving the roll stand has a lead. The speeds of the rolled strip upstream and downstream of the roll stand are linked to each other by the continuity condition, assuming volume constancy of the rolling stock during the rolling operation (see for this purpose, e.g., equation (3.9) on page 112 in H. Hoffmann, R. Neugebauer and G. Spur (ed.), “Handbuch Umformen”, 2nd edition, Carl Hanser Verlag, 2012, ISBN 978-3-446-42778-5).

Owing to the above-mentioned lag and lead of the rolled strip relative to the rotating working rolls, the control means is designed according to the invention to activate the rotary drive of the squeezing roller synchronously with the current speed of the rolled strip downstream of the roll stand. This means that, on the basis of the current rolled strip speed v downstream of the roll stand, the control means predetermines or activates (i.e., controls or regulates in the abovementioned sense) an angular speed for the rotary drive of the squeezing roller (which is identical to the angular speed ω of the squeezing roller itself because of the rigid connection between the roller drive and the roller shell) in such a way that the roller shell rolls on the rolled strip substantially without slipping. ‘Substantially without slipping’ in this connection means that a relative speed between the rolled strip surface and the surface of the roller shell can occur within the range of 0-1% of the rolled strip speed v downstream of the roll stand or is tolerated by the control means.

The above-mentioned design of the control means permits a particularly accurate speed control of the squeezing roller and, consequently, a particularly reliable avoidance of slip scratches irrespective of the current friction conditions between the squeezing roller and the rolled strip—and thus even during the use of cooling lubricants with a particularly high lubricant content of more than 10%. This advantageously prevents the unintended production of material that otherwise has to be scrapped at a later time. In addition, the energy required by such a synchronously driven squeezing roller of, for example, a power of 0.5 to 1 kW during continuous operation, is significantly lower than that, for example, of a blowing-off device for emulsion residues.

Furthermore, the positioning device is designed to move or to pivot the mount with the squeezing roller between a starting position A and an end position E. The starting position A and the end position E are arranged with respect to the roll stand and the diameter of the squeezing roller in such a way that, during rolling of a rolled strip in the roll stand (i.e., when the roll stand is closed), the roller shell of the squeezing roller, in the starting position A, does not touch the rolled strip, so that the rolled strip passes through the roll stand in a first strip running line B1. By contrast, in the end position E, the roller shell of the squeezing roller contacts the rolled strip on its upper side during rolling and deflects it downward into a second strip running line B2, as a result of which the cooling lubricant located on the rolled strip is discharged laterally from the upper side of the rolled strip.

Between the starting position A and the end position E, the squeezing roller is moved normally to a strip running line of the rolled strip. The roller shell extends transversely to the rolled strip beyond the latter and has, for example, a cylindrical shape and a length of up to two meters along the axis of rotation R of the squeezing roller.

In a preferred embodiment of the invention, the mount is formed in two pieces consisting of a first and a second mount part. In this connection, ‘in two pieces’ means that the first and the second mount part are two separate parts which are not directly connected to each other, for example by screwing, welding or any other rigid connection. The squeezing roller also has a first and a second roller pin, wherein the first roller pin is rigidly connected to the first mount part and the second roller pin is rigidly connected to the second mount part. The rotor is mounted within the stator so as to be rotatable relative thereto. Furthermore, the rotor is fixedly connected to a rigid shaft, wherein the rigid shaft is fixedly connected in turn to the roller shell via a flexible drive shaft.

In the described two-piece design of the mount, the first and the second mount parts are indirectly connected to each other via the squeezing roller. The rotary movement of the rotor located inside the squeezing roller is transmitted mechanically directly to the roller shell via the flexible shaft. This design enables the entire electric rotary drive to be located inside the squeezing roller. Specifically, this means that both the entire rotor and the entire stator—in particular with regard to the longitudinal axis of the squeezing roller—are located in the interior of the squeezing roller, and therefore only electrical connecting lines for the electric rotary drive lead out of the squeezing roller. This advantageously makes it possible to use a squeezing roller according to the invention as a retrofit solution or replacement for a squeezing roller without a rotary drive, since the outer dimensions of the—substantially cylindrical—squeezing roller can remain unchanged. Furthermore, by means of an electric rotary drive located entirely in the interior of the squeezing roller, the space required by the squeezing roller in the axial direction for installation between the two roll housings of the roll stand is advantageously minimized. The flexible drive shaft also makes it possible to compensate for small deviations in the mechanical alignment between the first and second mount parts (misalignment).

In a preferred refinement of the device according to the invention, the first roller pin is fixedly connected to a cooling shell for the stator, the cooling shell surrounding the stator and being fixedly connected thereto. Via the cooling shell, the heat generated by the electric rotary drive can be dissipated from said cooling shell, for example by cooling liquid being conducted through the cooling shell.

Preferably, the squeezing roller has a diameter of 300-500 mm. As a result, emulsion residues can be reliably removed from the rolled strip even when larger emulsion quantities of up to 2000 liters per minute are applied.

Preferably, the first roller pin and the cooling shell surrounding the stator have at least one cooling channel for conducting a cooling medium. For example, the cooling medium may be water. Since the first roller pin is rigidly connected to the first mount part, no rotary feedthrough is necessary for introducing a cooling medium into the first roller pin, and therefore mechanically robust active cooling for the electric rotary drive of the squeezing roller is advantageously made possible.

In a further preferred embodiment of the device according to the invention, the first and/or the second roller pin has/have a passage for introducing a gaseous medium, which is under positive pressure, into the interior of the squeezing roller. ‘Positive pressure’ refers here to a pressure level which is higher than the ambient pressure of the squeezing roller. Since the first and second roller pins are rigidly connected to the first and second mount parts, respectively, a simple and robust mechanical feedthrough in turn enables the generation of a positive pressure inside the squeezing roller with little effort. Gaseous media under positive pressure and having a very low water content—such as dried air, nitrogen or argon—can be provided cost-effectively and can protect the internal electric rotary drive of the squeezing roller against corrosion and the ingress of moisture or against dust and abrasion particles. When a gaseous medium with a higher thermal conductivity than air—such as helium—is introduced, a correspondingly greater heat dissipation from the electric rotary drive to the roller shell or to the environment also advantageously results.

In a further preferred embodiment of the device according to the invention, the first and the second mount part extend over 50-70 mm along the axis of rotation of the squeezing roller and have bevels on a respective contact surface with the positioning device, for example, with an angle β of 1-2°. At the respective contact surfaces, the first and second mount parts are connected to the positioning device via releasable fastening means, for example via screw connections.

The positioning device comprises, for example, two hydraulic actuators, each of which is assigned and connected to one of the mount parts. To move the squeezing roller into the starting position A or into the end position E, the two hydraulic actuators have to be moved synchronously, with it not being possible to entirely avoid unevenness in the movement of the actuators. Since the first and second mount part are substantially mechanically rigidly connected to each other via the squeezing roller, tilting torques may arise at the mount parts. The bevels thus allow a slight tilting of the mount parts relative to the positioning device or the actuators thereof and thus a dissipation of the induced tilting torques. In addition, the specified dimensions of the mount parts allow optimum use of the available space between the roll housings, so that the roller shell can have a large extent with respect to the width of the rolled strip and can reliably remove cooling lubricant even from rolled strips that have a maximum possible width with respect to the roll stand.

In a further preferred refinement of the device according to the invention, the control means is designed for feed-forward controlling of an angular speed ω of the squeezing roller on the basis of a torque characteristic curve Γ of the electric rotary drive.

In a cold rolling mill, for example, different rolled strips are connected (welded) to each other and rolled successively as what is referred to as an ‘endless strip’ by the individual roll stands of the cold rolling mill. The individual rolled strips generally have different properties—such as deformation resistance or strip thickness—which make it necessary that, when changing successive rolled strips, the roll nip of a roll stand, on which the device according to the invention is used, and/or the speed at which the different rolled strips are rolled, is/are changed. In order to keep the transition sections at the respective rolled strips as short as possible, such changes have to be made relatively quickly, i.e., within 20 to 50 meters in relation to the rolled strip length, for example.

A feed-forward control of the rotational speed of the squeezing roller on the basis of its torque characteristic curve Γ advantageously allows a rapid adjustment of the revolution speed of the squeezing roller, whereas, in a purely speed-based control of the squeezing roller, the speed thereof would be slower than that of the rolled strip during a speed change due to the inherent deceleration of the control loop over a certain period of time (control deceleration). This would result in turn in unwanted slipping between the squeezing roller and the strip surface.

Furthermore, a torque characteristic curve Γ for the electric rotary drive of the squeezing roller can be determined empirically by, for example, when the squeezing roller is first installed on the relevant roll stand, a rolled strip being rolled at several different speeds, with the squeezing roller being positioned in its end position against the rolled strip and the electric rotary drive being operated in a purely speed-controlled manner. If the respective torque of the electric rotary drive at which the angular speed of the squeezing roller corresponds to the respective strip speed downstream of the roll stand is determined (i.e., if the speed control has been adjusted to the relevant strip speed), the torque values thus determined represent the torque characteristic curve Γ as a function of the strip speed v (or the corresponding angular speed ω of the squeezing roller).

Therefore, knowledge of the torque characteristic curve Γ makes it possible, during a change of the speed v of the rolled strip, to directly predetermine the corresponding torque of the electric rotary drive, which is also referred to as ‘feed-forward control’. This advantageously adjusts the angular speed ω of the squeezing roller faster to a changed strip speed v.

In a further preferred refinement of the device according to the invention, the electric rotary drive is in the form of an asynchronous motor with the rotor as a short-circuit rotor and has a measuring means for detecting a current angular speed w′ of the squeezing roller (or of its roller shell). In particular, the measured angular speed ω′ can be an angular speed which is measured repeatedly over short time intervals of, for example, 10-100 milliseconds. This measuring means may comprise, for example, a pole wheel which rotates together with the roller shell and a rotation sensor which is arranged on the mount of the squeezing roller and contactlessly detects the rotational movement of the pole wheel.

A particular advantage of such a configuration is the fact that in this case permanent magnets can be completely dispensed with in the roller drive and there is therefore no undesirable deposits of magnetizable particles on the surface of the squeezing roller. In addition, contactless detection of the rotary movement of the pole wheel is particularly low in wear and—in the case of an inductive-based rotation sensor—also independent of dust and metallic particles. Furthermore, an advantage of the described configuration is that the rotation sensor 12 generating a measuring signal is arranged in a fixed position on the first and/or second mount part 20, 20′ and therefore a rotary feedthrough for corresponding signal lines to the rotating squeezing roller 3 can be dispensed with.

As an alternative thereto, according to a further preferred refinement, the rotary drive is in the form of a synchronous motor. In this case, a sensor-based detection of the angular speed ω of the squeezing roller can be dispensed with since the rotational speed of a synchronous motor is coupled to its drive frequency, and therefore the angular speed ω, which has to be predetermined for the squeezing roller, can be determined directly therefrom without further sensors, in order to obtain slip-free rolling on the rolled strip. Thus, for example, a pole wheel and a rotation sensor can be omitted and an even more compact design for the device according to the invention can be achieved.

Furthermore, the object is achieved according to the invention by a method for removing cooling lubricant during rolling of a rolled strip in a cold rolling mill mentioned at the beginning, on which a device according to the invention is arranged. In the method according to the invention
in a first step, before a strip head of the rolled strip is threaded into the roll stand, the control means activates the positioning device in such a way that the squeezing roller is moved into a starting position A,
in a second step, after the rolled strip is threaded into the roll stand, the control means activates the positioning device in such a way that the squeezing roller is moved into the end position E and deflects the rolled strip downward into a second strip running line B2, and
in a third step, the rolled strip is rolled in the roll stand, with cooling lubricant being applied to the rolled strip and the current speed v of the rolled strip downstream of the roll stand being measured and supplied to the control means, the control means activating the rotary drive in such a way that the roller shell rolls substantially without slipping on an upper side of the rolled strip and, in the process, discharges the cooling lubricant laterally from the upper side of the rolled strip.

The advantageous effects of the method according to the invention correspond to those of the device according to the invention.

### BRIEF DESCRIPTION OF THE DRAWINGS

The above-described properties, features and advantages of the invention, and the manner in which they are achieved, will become clearer and more clearly understandable in conjunction with the description of the following exemplary embodiment of the invention, which will be explained in more detail in conjunction with the figures. The same parts and mechanisms in the figures are each marked with the same identifiers. In the figures:

FIG. 1 shows a cross section through a squeezing roller according to the exemplary embodiment of the device according to the invention;

FIG. 2A shows a squeezing roller pivoted into starting position A on the roll stand according to the exemplary embodiment;

FIG. 2B shows a squeezing roller pivoted into end position E on the roll stand according to the exemplary embodiment;

FIG. 2C shows the squeezing roller from FIGS. 2A and 2B arranged on the roll stand with an positioning device, as seen opposite a first or second strip running line B1 or B2;

FIG. 3 shows a mount part for the squeezing roller according to the exemplary embodiment; and

FIG. 4 shows a block diagram of the device according to the invention.

### DETAILED DESCRIPTION

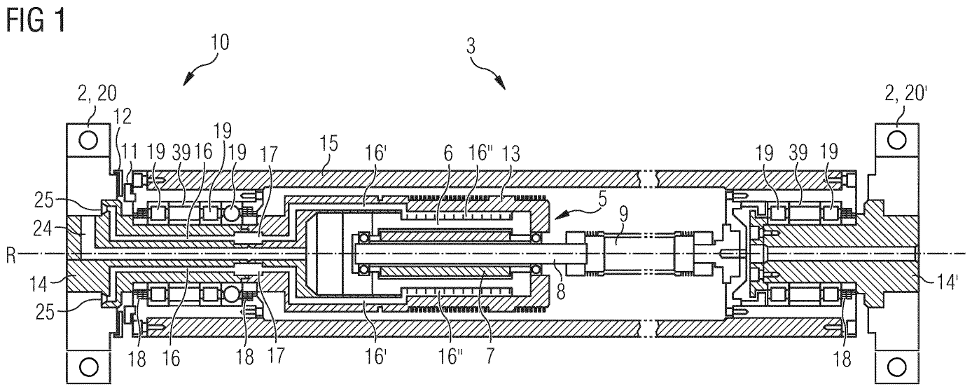

FIG. 1 shows a cross section through a squeezing roller 3 of an exemplary embodiment of the device 1 according to the invention. The squeezing roller 3 (specifically: the roller shell 15 thereof, which is in the form, for example, of a hollow cylinder) is mounted rotatably about an axis of rotation R at the two axial ends by means of bearings 19 and spacer bushings 39, in each case via a first and second roller pin 14, 14′ in a first and second mount part 20, 20′ of a mount 2. The first and second roller pin 14, 14′ is in each case rigidly connected to the first or second mount part 20, 20′ and in each case has a media connection 24 for introducing a gaseous medium into the interior of the squeezing roller 3, as a result of which a higher pressure level in relation to the ambient pressure is produced there and advantageously prevents the ingress of moisture and dust particles.

In addition, the first roller pin 14 has media connections 25 for the supply and discharge of a cooling liquid. The cooling liquid—for example water—is introduced in cooling channels 16 through the first roller pin 14 via feedthroughs 17 into cooling channels 16′ of a motor housing 13 of the electric rotary drive 5 of the squeezing roller 3 or discharged therefrom.

The motor housing 13 is fixedly connected to the first roller pin 14 and encloses the electric rotary drive 5. The rotary drive 5 is in the form of an internal rotor and comprises a rotor 7 located internally and a stator 6 located externally, as seen in the axial direction. The stator 6 has, for example, coil windings for generating an electromagnetic rotary field (not shown in FIG. 1) and is fixedly connected to the motor housing 13.

The introduced coolant flows out of the cooling channels 16′ of the motor housing 13 into corresponding cooling channels 16″ in or on the stator 6 and, as it flows through, absorbs waste heat generated by the rotary drive 5. In the present exemplary embodiment, the cooling channels 16″ are in the form of one or more spiral channels on the outer surface of the stator 6. The first and second roller pin 14, 14′, the motor housing 13 and the stator 6 form the fixed parts of the squeezing roller 3 with respect to the first and second mount parts 20, 20′. Furthermore, sealing rings 18 are arranged between the bearing seats of the bearings 19 and those parts of the squeezing roller 3 that are rotatable relative thereto, in order to prevent the ingress of fine particles into the bearings 19 or into the interior of the squeezing roller 3.

The rotor 7 is connected to a rigid output shaft 8, which protrudes in the axial direction from the motor housing 13 and is connected via a flexible drive shaft 9 to the roller shell 15 of the squeezing roller 3. The flexibility of the drive shaft 9 allows a certain mechanical offset normal to its axial direction (misalignment), but the drive shaft 9 behaves rigidly in relation to its circumferential direction.

Furthermore, the device 1 according to the invention comprises a measuring means 10 for detecting a current angular speed ω′ of the squeezing roller 3. According to the exemplary embodiment shown, the measuring means 10 is configured as pole wheel 11, which is arranged fixedly on the roller shell 15, in conjunction with a rotation sensor 12. The rotation sensor 12 is fastened to the first mount part 20 as a contactlessly operating measuring device and is designed to generate a signal that corresponds to a relative movement of the pole wheel 11, which rotates together with the roller shell. For reasons of redundancy, such a measuring device may also be arranged at both axial ends of the squeezing roller 3 (not shown in FIG. 1).

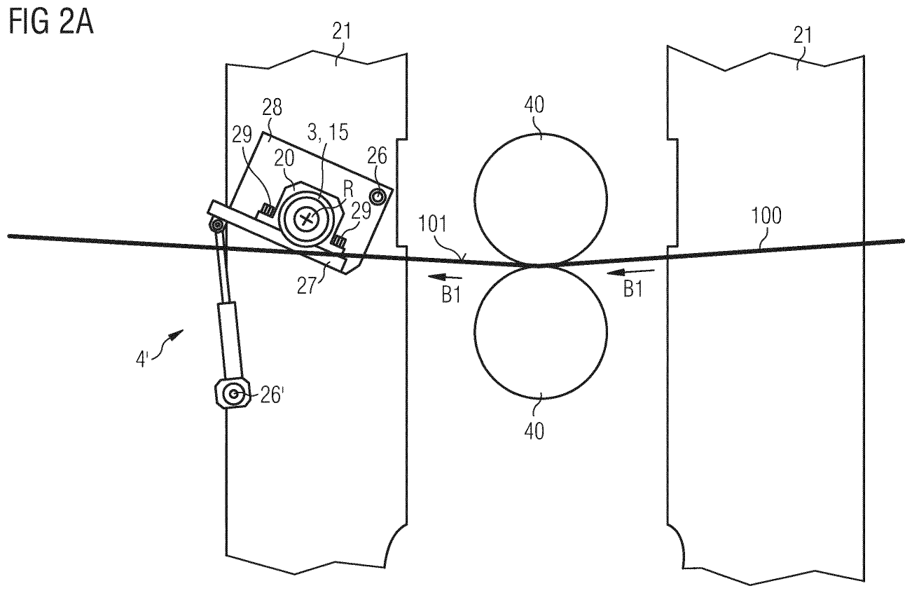

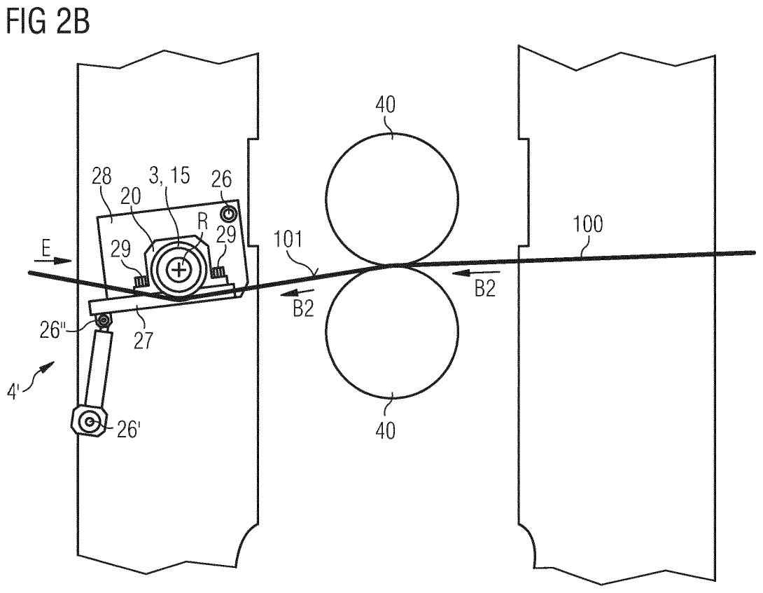

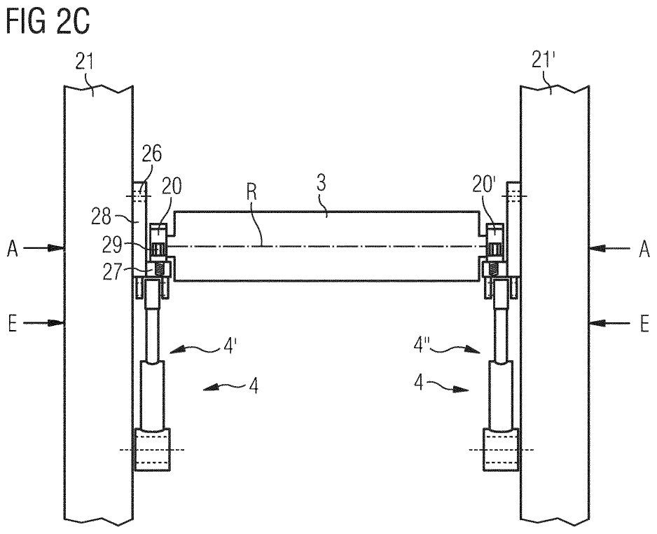

FIG. 2A shows a view of the exemplary embodiment from FIG. 1 along the axis of rotation R of the squeezing roller 3. The thick continuous line represents a flat rolled strip 100, which moves through the roll stand along a first strip running line B1 (running from right to left in FIG. 2A) upstream of a first roll housing 21 of the roll stand. Of the first roll housing 21, FIG. 2A shows only the central region in relation to its height with the stand window, but without working rolls and any other rolls. The roll stand is closed, i.e., the upper and lower working rolls 40 of the roll stand are each positioned on the rolled strip 100, which runs through the roll stand along a first strip running line B1. In the immediate region of the roll nip, the first strip running line B1 runs substantially horizontally—i.e., in a range of ±5°, with a slight deflection caused by rollers arranged upstream and downstream of the roll stand (not shown in FIG. 2A) being visible in FIG. 2A.

In the perspective shown, the squeezing roller 3 and its roller shell 15 are shown upstream of the first mount part 20 and are fastened rotatably thereto. The first mount part 20 is fastened via screws 29 to a base 27, which in turn is rigidly connected to a pivotable platform 28. The platform 28 is rotatably fastened to the first roll housing 21 by means of a first rotary fastening 26. Below the platform 28, a first actuator 4′ (in the illustrated exemplary embodiment in the form of a hydraulic cylinder) of a positioning device 4 is also rotatably fastened at its lower end to the first roll housing 21 via a second rotary fastening 26′. The actuator 4′ is rotatably fastened at the end opposite the second rotary fastening 26′ to the base 27 by means of a third rotary fastening 26″.

In FIG. 2A, the positioning device 4 or its first actuator 4′ is adjusted (hydraulic cylinder extended) in such a way that, in the starting position A, the squeezing roller 3 is positioned above the rolled strip 100 and therefore does not touch the upper side 101 of the rolled strip 100.

FIG. 2B shows the same view of the exemplary embodiment as FIG. 2A with the difference that the positioning device 4 or its first actuator 4′ is adjusted in such a way (hydraulic cylinder retracted) that the squeezing roller 3 is positioned in the end position E, with the roller shell 15 touching the upper side 101 of the rolled strip 100 and thereby deflecting the rolled strip 100 downward, so that the rolled strip 100 passes through the roll stand along a second strip running line B2. Excess coolant (not shown in FIG. 2B) accumulates on the infeed side in the hollow caused by the deflection—i.e., on the right of the squeezing roller 3 in FIG. 2B, and is subsequently discharged from the rolled strip 100 in the lateral direction transversely to the second strip running line B2 (i.e., normally to the drawing plane of FIG. 2B).

FIG. 2C shows a view of the exemplary embodiment from FIG. 1 parallel to the axis of rotation R of the squeezing roller 3 and opposite a first or second strip running line B1 or B2, wherein the squeezing roller 3 is in the starting position A above the end position E. Furthermore, it is shown that the squeezing roller 3, as seen in the direction of its axis of rotation R, is arranged between the first and second roll housings 21, 21′ of the roll stand and is rotatably mounted at its two axial ends in each case in the first and second mount parts 20, 20′. The first or second mount part 20, 20′ is in each case connected to a first or second actuator 4′, 4″ of the positioning device 4, as described in connection with FIG. 2A. To move the squeezing roller 3 between the starting position A and the end position E, the first and second actuators 4′, 4″ are moved synchronously with respect to each other.

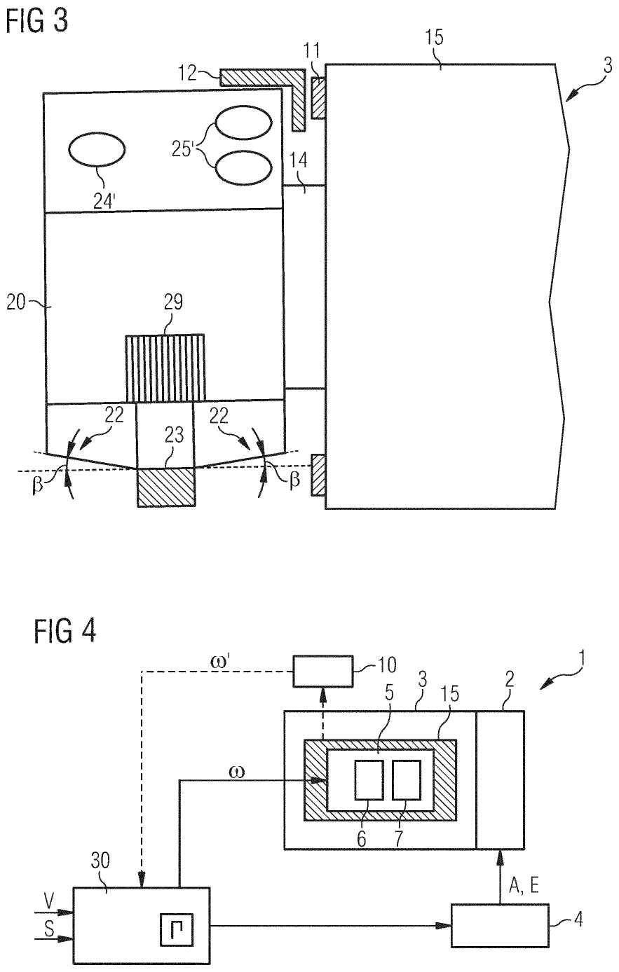

FIG. 3 shows a mount part 20 for the squeezing roller 3. The squeezing roller 3 is rotatably mounted in the first mount part 20 via the first roller pin 14. An air gap, for example of a few millimeters, remains between the rotation sensor 12 arranged on the first mount part 20 and the pole wheel 11 fastened to the roller shell 15. From the upper chamfer of the first mount part 20 there is a media connection 24′ for introducing the gaseous medium into the squeezing roller 3, or there are media connections 25′ for introducing and discharging cooling liquid into/from the squeezing roller 3. Corresponding media channels in the first mount part 20 lead into the mutually corresponding media connections 24, 25 in the first roller pin 14. The media connection 24 or 24′ is also used for the feeding through of the connections of the electric rotary drive 5. Since the first roller pin 14 is not rotatable and is connected fixedly to the first mount part 20, the corresponding transition points can be reliably sealed against the escape of cooling or gaseous medium. The media are thus conducted through the first mount part 20 into the squeezing roller 3, wherein the media connections 24′, 25′ are arranged on a surface of the first mount part 20, the normal vector of which is oriented perpendicular to the axis of rotation R of the squeezing roller 3. Thus, the space present between the first and second roll housings 21, 21′ can be advantageously readily utilized for the device 1 according to the invention.

Furthermore, it is shown in FIG. 3 that the first mount part 20 has a flat contact surface 23 on its underside in the region of the screw connection 29 for contact with the base 27 (this is not shown in FIG. 3). Transversely thereto, i.e., in the direction of rotation R of the squeezing roller 3, the underside of the first mount part 20 has bevels 22 in the form of chamfered surfaces, wherein the angle β between the contact surface 23 and the bevels 22 is in each case a few angular degrees, for example, 1-2°. The second mount part 20′ has similar bevels 22. The bevels 22 allow a slight tilting between the first and second mount parts 20, 20′, on the one hand, and the respectively associated base 27, so that, when the squeezing roller 3 is moved between the starting position A and end position E, slight asynchronicities between the individual actuators 4′ and 4″ of the positioning device 4 can be compensated for.

FIG. 4 shows a block diagram of the individual mechanisms of the device 1 according to the invention: the rotary drive 5 of the squeezing roller 3, the rotary drive having a stator 6 and a rotor 7, is fixedly connected to the roller shell 15, which is symbolized by hatching. When the squeezing roller 3 is positioned against the rolled strip 100 (end position E), a control means 30 activates the rotary drive 5 or predetermines for the latter an angular speed ω for the squeezing roller 3, which angular speed is a current speed v of the rolled strip 100 downstream of the roll stand (not shown in FIG. 4), so that the roller shell 15 rolls without slipping on the rolled strip 100.

A current speed v of the rolled strip 100 downstream of the rolling mill is continuously measured and supplied to the control means 30. The control means 30 determines the angular speed ω to be predetermined in the case of a rotary drive 5 in the form of a synchronous motor on the basis of the current speed v and the diameter of the roller shell 15 since, in this case, the angular speed of the electric rotary field generated by the stator 6 of the rotary drive 5 always corresponds to that of the rotor 7.

In the case of a rotary drive 5 in the form of an asynchronous motor, the control means 30 determines the angular speed ω, which is predetermined for the rotary drive 5, by additionally including the angular speed ω′ of the roller shell 15, which is determined with the aid of the measuring means 10 (dashed arrow in FIG. 4), since in this case the electric rotary field generated by the stator 6 precedes the angular speed of the rotor 7—depending on the current torque load of the rotary drive 5. In both cases (rotary drive 5 in the form of a synchronous or asynchronous motor), the angular speed ω to be predetermined can be determined by the control means 30 by including a torque characteristic curve Γ, in order to adapt the angular speed ω of the squeezing roller 3 to these changes more quickly when the speed v of the rolled strip 100 downstream of the roll stand changes.

Furthermore, in accordance with external control data S, which are supplied to the control means 30, the control means 30 controls the positioning device 4 in such a way that the squeezing roller 3 is moved between a starting position (A) and an end position E. With reference to the exemplary embodiment shown in FIG. 2C, the control means 30 activates the two actuators 4′, 4″ synchronously, so that the first and second mount part 20, 20′ of the mount 2 perform a synchronous movement for moving/pivoting the squeezing roller 3. The control data S substantially depend on the condition of the rolled strip 100 rolled in the relevant roll stand (if, for example, no rolled strip 100 or only the beginning thereof is currently moving through the roll stand, the squeezing roller 3 has to be moved into the starting position A, in order to allow undisturbed threading-in of the rolled strip 100) and, for the control means 30, predetermine the time at which the squeezing roller 3 should be positioned against the rolled strip 100 running through the roll stand or moved away therefrom.

### LIST OF REFERENCE SIGNS

1 Device
2 Mount
3 Squeezing roller
4, 4′ 4″ Positioning device, actuator
5 Electric rotary drive
6 Stator
7 Rotor
8 Output shaft
9 Flexible drive shaft
10 Measuring means
11 Pole wheel
12 Rotation sensor
13 Motor housing
14, 14′ Roller pin
15 Roller shell
16, 16′, 16″ Cooling channel
17 Feedthrough
18 Sealing ring
19 Bearing
20, 20′ Mount part
21, 21′ Roll housing
22 Bevel
23 Contact surface
24, 24′ Media connection for gas
25, 25′ Media connection for cooling liquid
26, 26′, 26″ Rotary fastening
27 Base
28 Platform
29 Screw
30 Control means
39 Spacer bushing
40 Working roll
100 Rolled strip
101 Upper side of the rolled strip
A Starting position
B1, B2 First, second strip running line
E End position
R Axis of rotation
S Control data
v Speed of rolled strip
β Angle
ω, ω′ Angular speed

1-12. (canceled)

13. A device for removing cooling lubricant during rolling of a rolled strip in a cold rolling mill with at least one roll stand, comprising
a squeezing roller configured to be arranged between a first and a second roll housing of the roll stand, the squeezing roller having a roller shell and an internal electric rotary drive;
a mount, in which the squeezing roller is mounted rotatably about an axis of rotation;
a positioning device for positioning the squeezing roller against the rolled strip; and
a control means for activating the rotary drive and the positioning device;
wherein the rotary drive is fixedly connected to the roller shell, has a stator and a rotor and is embodied as an internal rotor;
wherein a current speed of the rolled strip downstream of the roll stand is known to the control means, and the control means is configured to activate the rotary drive synchronously to the current speed of the rolled strip downstream of the roll stand;
wherein the positioning device is configured to move the mount with the squeezing roller between a starting position and an end position;
wherein, during rolling of the rolled strip in the roll stand, the roller shell:
does not touch the rolled strip in the starting position, such that the rolled strip passes through the roll stand in a first strip running line, and
makes contact to the rolled strip on an upper side in the end position and deflects the rolled strip downward into a second strip running line.

14. The device as claimed in claim 13, wherein:
the mount is formed in two pieces consisting of a first and a second mount part and the squeezing roller has a first and a second roller pin;
the first roller pin is rigidly connected to the first mount part and the second roller pin is rigidly connected to the second mount part; and
the rotor is fixedly connected to a rigid shaft, which is fixedly connected to the roller shell via a flexible drive shaft.

15. The device as claimed in claim 14, wherein the first roller pin is fixedly connected to a cooling shell for the stator, the cooling shell surrounding the stator and being fixedly connected thereto.

16. The device as claimed in claim 13, wherein the diameter of the squeezing roller is 300-500 mm.

17. The device as claimed in claim 13, wherein the first roller pin and the cooling shell have at least one cooling channel for conducting a cooling medium.

18. The device as claimed in claim 13, wherein at least one of the first roller pin and the second roller pin has a passage for introducing a gaseous medium, which is under positive pressure, into the interior of the squeezing roller.

19. The device as claimed in claim 13, wherein the first and the second mount part extend over 50-70 mm along the axis of rotation and have bevels on a respective contact surface with the positioning device.

20. The device as claimed in claim 13, wherein the control means is designed for feed-forward controlling of an angular speed of the squeezing roller on the basis of a torque characteristic curve of the electric rotary drive.

21. The device as claimed in claim 13, wherein the electric rotary drive is embodied as an asynchronous motor with the rotor as a short-circuit rotor and has a measuring means for detecting a current angular speed of the squeezing roller.

22. The device as claimed in claim 21, wherein the measuring means comprises a pole wheel arranged on the squeezing roller and a rotation sensor arranged on the mount.

23. The device as claimed in claim 13, wherein the electric rotary drive is in a form of a synchronous motor.

24. A method for removing cooling lubricant during rolling of a rolled strip in a cold rolling mill with at least one roll stand on which a device as claimed in claim 13 is arranged, the method comprising:
in a first step, before a strip head of the rolled strip is threaded into the roll stand, activating by the control means the positioning device so that the squeezing roller is moved into a starting position;
in a second step, after the rolled strip is threaded into the roll stand, activating by the control means the positioning device so that the squeezing roller is moved into the end position and deflects the rolled strip downward into a second strip running line; and
in a third step, the rolled strip is rolled in the roll stand, with cooling lubricant being applied to the rolled strip and the current speed of the rolled strip downstream of the roll stand being measured and supplied to the control means, activating by the control means the rotary drive so that the roller shell rolls substantially without slipping on an upper side of the rolled strip and, in the process, discharges the cooling lubricant laterally from the upper side.
